(19) United States
(12) Patent Application Publication
(10) Pub. No.: US 2018/0232676 A1
(43) Pub. Date: Aug. 16, 2018

(54) Fulfillment Success Prediction for Product Procurement

(71) Applicant: Cimpress Schweiz GmbH, Winterthur (CH)

(72) Inventors: Michael Edward Hlasyszyn, Pembroke, MA (US); Anu K. Mani, Acton, MA (US)

(73) Assignee: Cimpress Schweiz GmbH, Winterthur (CH)

(21) Appl. No.: 15/429,303

(22) Filed: Feb. 10, 2017

(51) Int. Cl. G06Q 10/06; G06Q 10/04; G06Q 30/06

(52) U.S. Cl. CPC G06Q 10/06375; G06Q 10/06315; G06Q 30/0641; G06Q 30/0633; G06Q 10/04

(57) ABSTRACT

Fulfillment success prediction capability for use in product fulfillment, in particular electronic product procurement systems, reveals statistical confidence that an item to be procured will be successfully fulfilled by a supplier.

### BACKGROUND

As part of their normal operation, manufacturers and merchants must routinely procure materials and products from suppliers (who may in turn be a manufacturer or merchant). A retailer merchant, for example, may procure products from many different suppliers for resale directly to end-consumers, while a wholesaler merchant procures products for resale to other merchants or manufacturers. In a manufacturing operation, a manufacturer may procure materials, parts, components and other products used in the production of the particular products made by the manufacturer. Product procurement may involve many steps, including supplier identification, pricing analysis, contractual terms negotiation, and others, and the particular steps followed in the product procurement process may vary from business to business. What is common across procurement operations is, at the end of the day, a product gets ordered from a supplier.

Products are now routinely procured electronically—that is, orders for products are very often placed with suppliers via electronic order submission, for example through the submission of electronic order data via a form on a supplier website or via an application programming interface (API) through which a supplier retrieves or receives electronic data representing product order(s). Of course, more traditional methods of transmitting and receiving product orders are still used by many businesses, such as mail-in and fax ordering, and phone and in-person ordering, but electronic order submission is rapidly becoming the norm.

It is axiomatic that when a product order is submitted to a supplier by a procurer, the procurer reasonably expects the ordered products to be supplied. Yet, as is often the case, processes and systems may not operate as planned, and the act of placing an order does not guarantee that the ordered product will be successfully fulfilled. There may be a host of reasons that an ordered product fails to be fulfilled, including, to name just a few, transmission errors, failure on the supplier's part to receive or process the order, incorrect format of the order, missing order data, incompatible available variants of the product ordered, lack of availability at the supplier for the ordered product, production issues or delays at the supplier/manufacturer, and many other circumstances that prevent fulfillment of the ordered product. Regardless of the reason why a placed order may not be fulfilled, the procurer ordering the product would generally like to know, prior to placing the product order, how confident they should expect to be that the placed order will be fulfilled. Currently, no system provides a solution to this problem.

Additionally, when a products procurer desires to test and/or add a supplier to their procurement network, the procurer and supplier often begin the relationship by implementing a test phase, during which the procurer sends a number of test orders to the supplier and the supplier fulfills the test orders. During the test phase, the procurer and supplier may attempt to ensure that the ecommerce interface, through which orders are placed and placed orders are received and/or picked up by the supplier, is working properly. Further during the test phase, the procurer may place orders for actual fulfillment in order to evaluate the capabilities and timeliness of the supplier in fulfilling products ordered therefrom.

For a supplier that offers a large range of different products (including different orderable variations thereof), the testing phase may take a very long time to fully vet how well the supplier is able to fulfill each and every item it offers to fulfill. Furthermore, where a supplier offers a large range of different products, understanding the fulfillment success of various categories of products naturally as orders flow in becomes a critical factor in gauging the quality, especially in gauging the quality of products which the supplier did not test directly. From the procurer's perspective, it is important to know how confident the procurer can be that products ordered from a given supplier will be successfully fulfilled. The procurer may rate a supplier, and make decisions concerning use of the supplier, based on historical performance, namely the numbers of successful versus failed fulfillments, of products ordered from that supplier. The procurer generally does not perform any deeper evaluation of the supplier, for example by looking into a product by product success rate of the supplier, or by monitoring changes in success and failure rates over time. From the supplier's perspective, the supplier may be really good at fulfilling certain products but have trouble fulfilling certain other products, which may result in pulling down the procurer's rating level of the supplier. Furthermore, the supplier may make changes in their system and significantly improve the fulfillment success rate of products that it previously had trouble fulfilling, yet the procurer's rating of the supplier does not reflect the improvement, or is slow to catch up. Accordingly, it would be desirable for procurer and suppliers to have a way to predict a confidence level of fulfillment success on a product-by-product basis, and which takes into account changes in success rates over time.

### SUMMARY

For all of the above reasons, it would be desirable to have an electronic procurement system which includes fulfillment success prediction capability from which decisions can be based on whether to use a particular supplier and/or which supplier to use when ordering a particular product or service. Such would be particularly helpful when a procurer is looking for alternative suppliers of products, for example during times of peak demand or when calamity strikes the go-to supplier. It would be further desirable to be able to extract fulfillment success prediction on a product-by-product basis. To this end, it would further be desirable to have a system which analyzes and predicts fulfillment success of an ordered product from a given supplier.

It would further be desirable for the system to allow for testing of fulfillment success of products from new suppliers prior to making the product available for procurement from such new suppliers.

It would further be desirable to allow for testing the fulfillment success of only a subset of items from a much larger catalog and/or category of items to use the fulfillment success confidence level to represent the full population of the catalog or category of items. Such would allow a much reduced testing time for product fulfillment testing of thousands or millions of catalog items.

It would further be desirable for the system to allow for testing of fulfillment success of new or additional products from a known supplier prior to making the product available for procurement from such supplier.

In an embodiment, an electronic procurement system includes fulfillment success prediction capability that enables a procurer (such as a retailer, a wholesaler, a manufacturer, or an end-consumer) the ability to understand how confident they can be that an order placed with a supplier for a product will be successfully fulfilled.

In accordance with other aspects of the invention, a product fulfillment rating system is provided which includes a fulfillment success prediction module that analyzes historical fulfillment and/or commerce event data on a product-by-product basis, and generates a prediction indicator indicative of how confident one can be that an order for a particular product will be fulfilled. The historical fulfillment and/or commerce data events may include, for example, success and failure events associated with historical orders of products. In an exemplary embodiment, the fulfillment success prediction module calculates a statistical confidence level based on historical performance and a weighted set of influencing factors. In an embodiment, the product fulfillment rating system sums weighted influencing factors and maps the sum to a point on a sigmoidal transfer function curve to generate a confidence value corresponding to the expected confidence of successful fulfillment of the corresponding catalog item or category. The confidence value can optionally be scaled proportionally to a desired rating scale to produce a scaled rating for fulfillment success predictability of the corresponding catalog item or category.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a high-level block diagram of an environment 1 in which aspects of the invention may be implemented;

FIG. 2 is a schematic block diagram illustrating an exemplary embodiment of a fulfillment success prediction system;

FIG. 3A is an architectural diagram illustrating an embodiment of an exemplary data format of fulfillment events;

FIG. 3B is an architectural diagram illustrating another embodiment of an exemplary data format of fulfillment events;

FIG. 4 is a schematic diagram illustrating an exemplar, embodiment of confidence calculation model that may be used as a confidence model to calculate fulfillment success confidence based on certain information extracted from fulfillment event data;

FIG. 5 is a graph illustrating a sigmoidal function for various values of φ;

FIG. 6 is a schematic diagram of an example artificial neural network;

FIG. 7 is a schematic diagram of an individual artificial neuron which may be used to implement the individual neurons in the artificial neural network of FIG. 6;

FIG. 8 is a schematic block diagram of an exemplary computing device which may be used in implementing any of the computer systems, servers, mobile devices, networked devices, and/or components of such systems; and

FIG. 9 is a flowchart illustrating an exemplary communications flow in accordance with an embodiment.

### DETAILED DESCRIPTION

### Definitions

The term “product” is used generically to refer to a material, a component, a part, or a composite which incorporates any of the foregoing in any quantity, and/or associated intangibles such as a service and/or associated fee.

The term “catalog item” refers to a product orderable from a supplier.

The term “item” is used to refer to a single catalog item.

The term “procurer” refers to a merchant (retailer, wholesaler, or distributor), a manufacturer, or an end-consumer, who places orders for products from a supplier.

The term “supplier” refers to a manufacturer, or a merchant (retailer, wholesaler, or distributor), who offers one or more products for fulfillment.

The term “fulfillment” refers to producing, manufacturing, retrieving from inventory, procuring from a supplier, or otherwise supplying, an ordered product and delivering such ordered product via an agreed delivery form, and/or, in the case where the ordered product includes a service or associated fee, performing, dispatching or enabling a service associated with the ordered service or associated fee. The agreed delivery form may be, by way of example only and not limitation, one of the following forms: placing the ordered product into the hands of a shipping or delivery service, making the ordered product available at an agreed-upon pickup location, delivering the ordered product to an agreed upon address or placing it into the hands of an agreed upon person or entity, etc.

The term “order” is used to refer to a request, specified in a format acceptable to a supplier, to supply a specified quantity of a particular product. The request format acceptable to the supplier may be in a format specified by the supplier, or may be a format specified by a merchant or other party which the supplier recognizes and accepts. When an “order” is “placed” with a supplier, the order is submitted, in a format acceptable to the supplier, via a method of transmission acceptable to the supplier. The order submission format and method of transmission may be as specified by the supplier, or may be specified by a merchant or other party which the supplier recognizes and accepts. Typical methods for submitting an order that may be acceptable to a supplier include: completing an ordering process or form on a supplier website or at a kiosk through which products can be ordered from the supplier and following the associated checkout process, transmitting over a network (typically over the Internet) an order via an Application Programming Interface (API) recognized by the supplier as an order placement channel, placing an order in person or via telephone with a representative of the supplier, emailing an order form to a supplier, and sending to a supplier a faxed-, or mailed-in physical order form.

The term “category” is used to refer to items that may be related and/or are designated to be tracked together.

A “fulfillment event” is a predefined occurrence of a procurement and/or supplier event that affects one or more confidence level calculations by a fulfillment success prediction system.

Procurement System Environment Overview

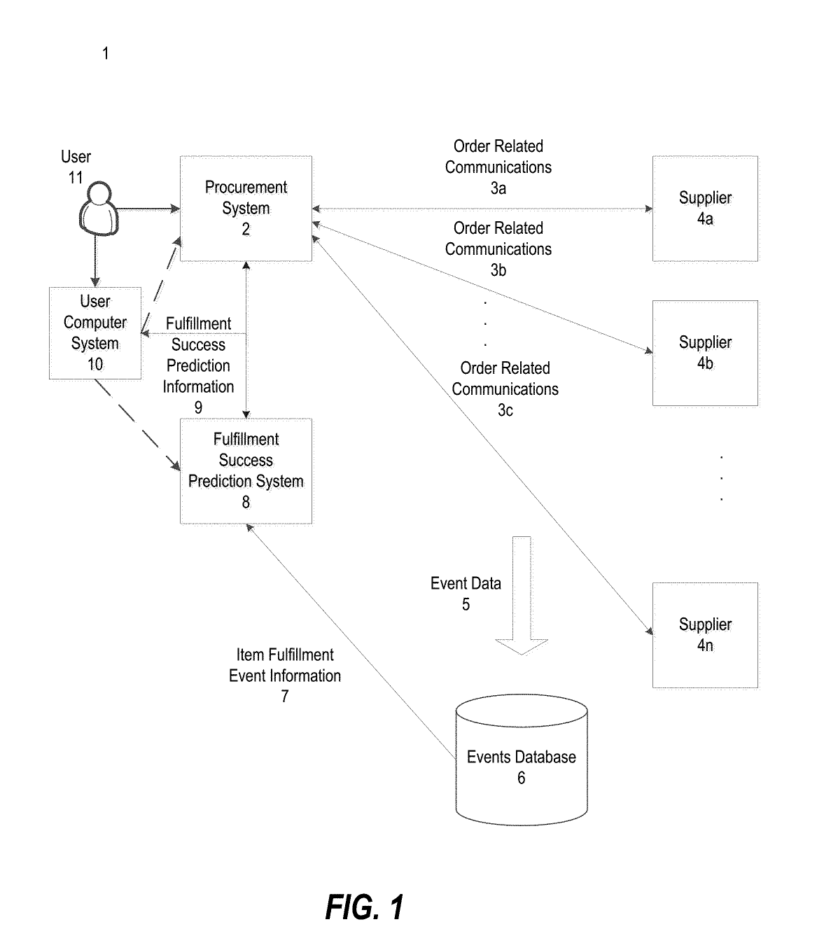

FIG. 1 is a high-level block diagram of an environment 1 in which aspects of the invention may be implemented. As shown therein, a user 11 interacts directly with a product procurement system 2 via a user interface (not shown), or via a remote user computer system 10, which provides remote interaction with the product procurement system 2. Via the user interface, the user can view, select, add, remove, and edit products, product information, suppliers, and/or supplier information used by the procurement system 2 for the procurement of products, and further may place orders and, cancel orders, for products. The product procurement system 2 communicates (via order related communications 3a, 3b, . . . 3n) with one of more suppliers 4a, 4b, . . . 4n to order products from the suppliers. In an embodiment, the product procurement system is network enabled and order related communications 3a, 3b, . . . 3n are messages sent over a network using a network protocol. For example, communications 3a, 3b, . . . 3n are transported via the Internet using a standard protocol such as, by way of example and not limitation, HTTP or HTTPS. Other types of networks and associated protocols may alternatively be used to transport the communications 3a, 3b, . . . 3n.

Procurement event data 5 is collected and stored in an events database 6. A fulfillment success prediction system 8 sources item fulfillment event information data 7 from the events database 6. The fulfillment success prediction system 8 analyzes fulfillment event information data 7 and produces, on a per-item and/or per-category basis, a confidence level indicating how statistically confident the system is that an item and/or items in a category, if ordered, will be successfully fulfilled. The fulfillment success prediction system 8 may track the fulfillment performance of an item, multiple different items, a category of items, multiple different categories of items, and multiple different suppliers. The procurement system 2 requests and evaluates, on a per-item and/or per-category basis, fulfillment success prediction information 9 from the fulfillment success prediction system 8, and using information 9 may generate a report indicating per-item and/or per-category confidence level information (which may further include per-supplier information). The report may be processed by the procurement system 2 directly, or may be viewed and used by a human 11 operating or interfacing with the procurement system 2 (either directly, or via a remote user computer system 10), to make procurement decisions regarding which items to order from which suppliers 4a, 4b, . . . , 4n, based on confidence levels and/or ratings provided by the fulfillment success prediction system 8.

Fulfillment Success Prediction Capability

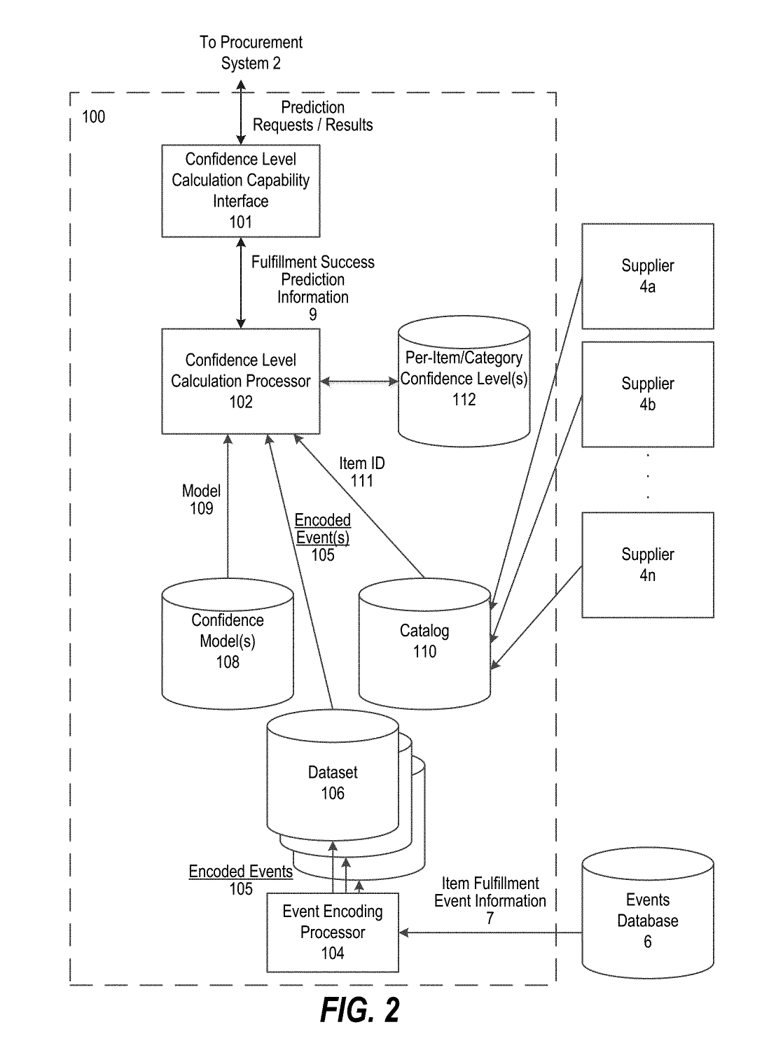

FIG. 2 is a schematic block diagram illustrating an exemplary embodiment 100 of the fulfillment success prediction system 8 of FIG. 1. At the heart of the fulfillment success prediction system 100 is a confidence level calculation processor 102 which executes and/or simulates a confidence model 109 on incoming per-item or per-category encoded event data 105 to generate fulfillment success confidence level predictions on a per-catalog item or per-category basis.

Certain procurement-related events may occur during the procurement of a product. Examples of procurement-related events may include events related to status of availability of items, pricing offers, quotes and/or related messages, order submission and acknowledgement, order change/cancellation requests, payment processing messages, data upload/download, order status messages, among others. Within the overall set of procurement-related events lies a subset of fulfillment events that are relevant to the calculation of a fulfillment success confidence level of a given item and/or category of items. Such fulfillment events may include, by way of example and not limitation, order status and fulfillment status events.

Generally, where it is desirable to track a particular type of event for a particular purpose, such event is recorded and logged in an events database 6 or other such storage resource. In an embodiment, each logged event results in the storage of an associated event record which stores relevant information associated with the event. In an embodiment, an event record preferably includes an identifier which uniquely identifies the associated event, and further includes various metadata, including, for example, an event type which identifies the specific type of the associated event, a date-time stamp which records the date and time of the event, an item (and/or category) identifier which identifies the item/category whose fulfillment processing triggered the event, an order identifier associated with the item/category that triggered the event, and other data of interest associated with the event. In an embodiment, fulfillment event types include:
Order Accepted Event: supplier accepts the responsibility of fulfilling an ordered item.
Shipped Event: indicates item has been shipped and successfully fulfilled.
Cancellation Request Event: procurer-initiated cancellation.
Change Request Event: supplier receives a procurer-initiated request to modify the order or change the terms of delivery; supplier accepts or rejects change request.
Supplier Rejected Event: represents a supplier initiated cancellation because the supplier cannot fulfill the ordered item.

The events database 6 may be a proprietary database, or may be a commercial database management system such the commercial database as Amazon® Redshift. The events database 6 may be a local storage resource, a networked database accessible by remote clients over a local or wide area network, or alternatively a cloud-based storage resource accessible through a web service.

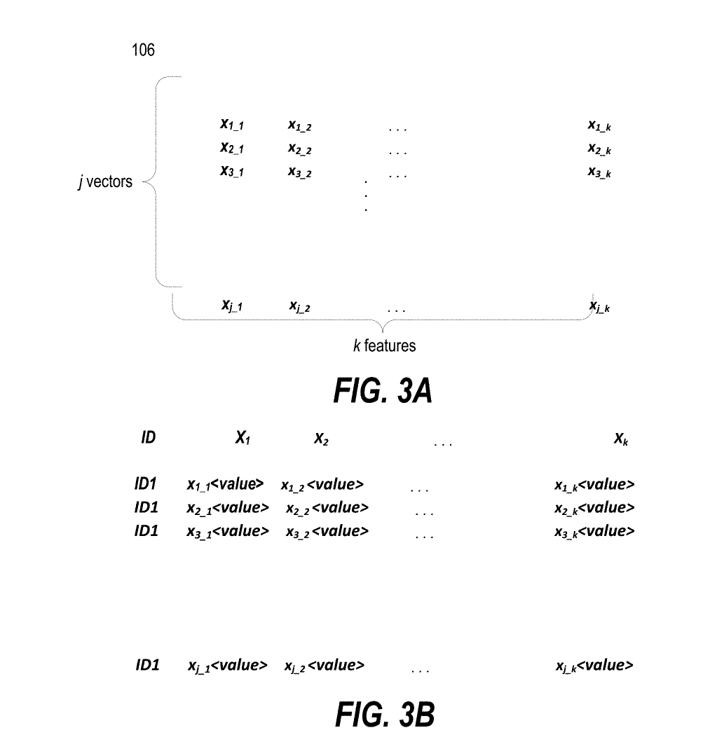

The fulfillment success prediction system 100 includes an event encoding processor 104 which receives and/or retrieves item fulfillment event information 7 and encodes it into a data format usable by the confidence level calculation processor 102 (and model 109) for calculating a confidence level associated with an item or category. In this regard, and with reference to FIG. 3A, item fulfillment event information 7 is processed to create a dataset, which comprises a set of j (jϵIntegers≥1) input vectors x, where each input vector x comprises k (kϵIntegers≥1) features. The values of the features xⱼ_{_}₁, xⱼ_{_}₂, . . . , xⱼ_{_}ₖ of a given vector, xⱼ, correspond to k different input variables of the confidence model 109. Each input vector xⱼ is associated with at least one item, and optionally, a category.

Dataset(s) 106 may be stored in computer readable memory and may be stored as one or more files, or in a database such as, but not limited to, a relational database, or made available in some other data resource. In an embodiment, a separate dataset 106 is maintained for each catalog item, and optionally also for each category of related catalog items. Maintaining separate dataset files or directories for the dataset associated with each tracked item/category can simplify the retrieval of input vectors associated with a particular item/category whose confidence level is being calculated. For example, when the confidence level calculation processor 102 receives a request for a confidence level associated with a given item or category, the confidence level calculation processor 102 can retrieve all input vectors contained in a particular dataset file or directory that is predetermined to be associated with the item. This methodology requires pre-filtering the input vectors by item/category, but has the advantage of a simpler input vector retrieval implementation since all input vectors from the dataset 106 that match the item identifier of the given item are placed in a common predetermined file and/or directory.

In an alternative embodiment, dataset 106 may mix input vectors associated with different items or categories as long as an association of each vector to the item or category to which it is associated is recorded and maintained in the dataset itself. In such alternative embodiment, in order to calculate a per-item/category confidence level, the dataset 106 must be filtered to obtain the subset of input vectors in the dataset 106 that are associated with the particular item or category whose confidence level is being processed. FIG. 3B illustrates such an example. As shown, the input vectors associated with all different items and categories are stored in one or more file(s) or database(s), as retrievable <ID:vector> pairs. When the confidence level calculation processor 102 receives a request for a confidence level associated with a given item or category, the confidence level calculation processor 102 retrieves only those input vectors from the dataset 106 that match the item/category identifier of the requested item/category.

An items catalog 110 contains associations between each catalog item/category ID, as understood by the procurement system, and corresponding supplier item/category identifiers. The association may be stored as a table, as XML <ID:vector> pairs, or any other suitable data storage construct. Catalog items are those items that may be ordered from suppliers. Typically, each individual supplier 4a, 4b, . . . , 4n provides the procurement system 2 with its own product identifiers associated with items that the particular supplier makes available to the procurement system for ordering. The catalog item/category identifiers are used by the confidence level calculation processor 102 and event encoding processor 104 to track and sort item fulfillment event information 7 into dataset(s) 106 and to sort and retrieve input vectors on an item/category basis. Thus, when the confidence level calculation processor 102 performs a confidence level calculation for a particular catalog item, or generates a confidence model 109 associated with that particular catalog item/category, only events that are associated with that particular catalog item/category are used in the calculation of the confidence level. Such events are identified by correlating the item/category IDs from procurement system generated events and supplier generated events using the associations made available in the items catalog 110.

In an embodiment, the confidence level calculation processor 102 is a computer processing unit that executes computer-readable code implementing a confidence model 109. The confidence model 109 is a software- or hardware-implemented device which receives fulfillment event information associated with an item or category in the form of an input vector from a dataset 106 and generates a confidence level representative of the predicted fulfillment success for a particular catalog item or category. As described hereinafter, the artificial neural network is first trained using a test dataset which embodies fulfillment events that are either in fact production data, or which are known to be typically seen by a procurement system. The trained neural network is then stored in computer-readable storage 108 as a data model 109 and may be used to process realtime per-item/category input vectors to update the fulfillment success confidence levels associated items and categories of items. Confidence levels can be calculated and produced on a per-request basis (for example, upon receipt from the procurement system of a request for a confidence level of a particular item/category), or alternatively may be calculated according to a schedule, or upon live update of dataset data, and stored in computer-readable memory for quick retrieval such as a database or other data store.

In an embodiment, the same confidence model 109 is used to generate fulfillment success confidence levels regardless of catalog item or category type. In alternative embodiments, different respective neural networks may be trained and used in production to predict confidence levels for different respective catalog items and/or categories, where the different models are tuned to the specific datasets characteristic of the respective catalog item/category associated with the specific dataset.

### First Embodiment Confidence Level Calculation

Artificial neural networks are more interestingly applied where the confidence level calculation involves a relatively large number of influencing factors. Simpler models may be better suited when only a small few influencing factors contribute to the confidence level calculation.

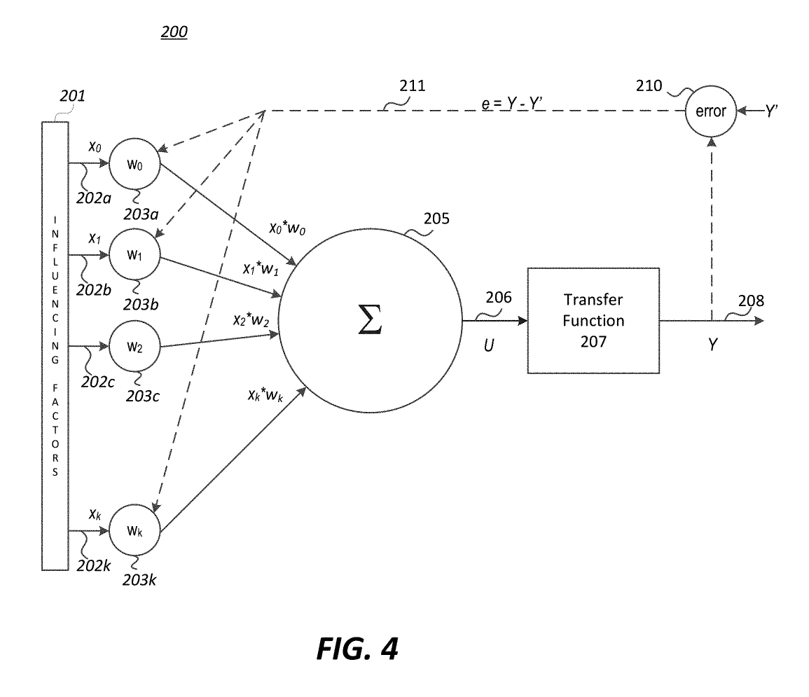

FIG. 4 is a schematic diagram illustrating a simple, yet exemplary, embodiment of confidence calculation model 200 that may be used as a confidence model 109 (see FIG. 2) to calculate fulfillment success confidence based on certain information extracted from fulfillment event data. As shown, influencing factors 202a, 202b, . . . , 202k, which may be extracted from item fulfillment event information 7, are respectively fed as input to respective multipliers 203a, 203b, . . . , 203k. Each multiplier 203a, 203b, . . . , 203k has an associated weight, or bias, that is an indicator to how strongly to consider the respective influencing factor 202a, 202b, . . . , 202k. In the preferred embodiment, a weight w₁, w₂, . . . , wₖ can have a value between −1.0 to 1.0 (400% to 100%) inclusively. If the weight is positive, the influencing factor will have a “positive” impact on the output of the summing unit 205. If the weight is negative, the influencing factor will have a “negative” impact on the output of the summing unit 205. When the weight assigned to an influencing factor lies closer to 1.0 or −1.0, more of the influencing factor value will be considered in both the positive and negative directions. The weight of an influencing factor diminishes the closer it is to 0.0.

Each multiplier 203a, 203b, 203k receives a respective influencing factor value (x₁, x₂, . . . , xₖ) and multiplies it by its associated weight value (w₁, w₂, . . . , wₖ) to produce a corresponding weighted influencing factor value (x₁w₁, x₂w₂, . . . , xₖwₖ). The summing unit 205 then sums the weighted influencing factor values (x₁w₁, x_{z}w_{z}, . . . , xₖwₖ) together to formulate a summation result (Uⱼ) 206. This can be expressed as:

$$U = {\sum }_{i = 1}^{k} {x}_{i} {w}_{i}$$

$$U = ( {x}_{1} \times {w}_{1} ) + ( {x}_{2} \times {w}_{2} ) + … + ( {x}_{k} \times {w}_{k} ) .$$

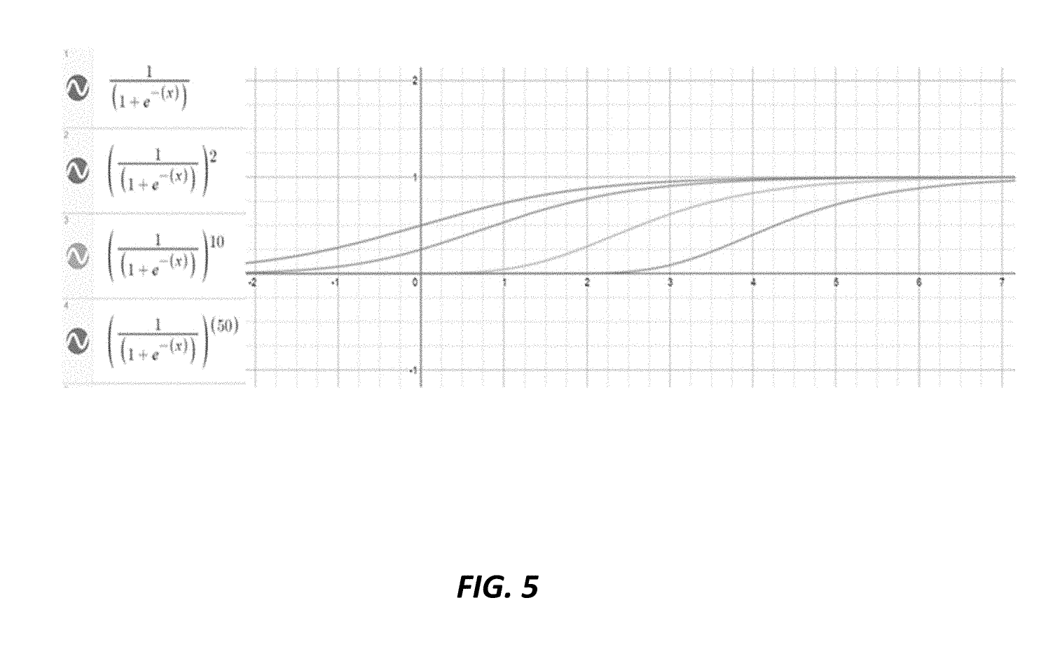

The summation result (U) 206, is then input to a Transfer Function 207 to generate the confidence value (Y) 208. A confidence value is a floating point number with values between 0.0 and 1.0 inclusively. In the preferred embodiment the Transfer Function 207 used in item/category-level confidence calculations is expressed as a sigmoidal function, illustrated in FIG. 5. As shown in FIG. 5, as the summation result (U) 206 increases from zero (along the x-axis), the confidence value (y-axis) will slide along the sigmoidal function producing a gradient (“s-curve”) of values ranging between 0.0 and 1.0 inclusively.

The Transfer Function equation is given by:

$$Y = {( \frac{1}{1 + {e}^{- U}} )}^{ϕ} ,$$

where φ>0. In the illustrative embodiment, φ=10. As φ increases from zero, the position of the Transfer Function changes along the x-axis along with increasing the slope of the function. These variations can be seen in FIG. 5 for values of φ set to 1, 2, 10, and 50. A preferred value of for the Transfer Function is 10, but of course may be adjusted up or down depending on how much historical data one wants to take into account and how quickly one wants to allow the function to learn and adjust as more data comes in.

As stated previously, in the preferred embodiment, the confidence value is a floating point number with values between 0.0 and 1.0 inclusively. Once can translate the confidence value to a different scale to put it in a form more palatable for a human evaluator. For example, for reporting purposes, humans may prefer to view and/or understand where the confidence value lies on a scale of 1 to 10, or 1 to 5, or even binary 0 vs. 1 format for use in a go/no-go application. For purposes of discussion herein, the scale is referred to as a rating scale. To translate the confidence value to a point on the rating scale, the confidence value (Y) is then multiplied by the maximum value on the rating scale, which increases the confidence value proportionally with the scale value. For example, if the rating scale is a 5-point scale, confidence values ranging from 0.0 to 1.0 will create Rating values ranging from 0.0 to 5.0, whereas if the rating scale is a 10-point scale, confidence values ranging from 0.0 to 1.0 will create Rating values ranging from 0.0 to 10.0.

Table 1 illustrates an example report containing calculated Confidence and Rating values based on example data. In the example given in Table 1, there are only two influencing factors, x₁ and x₂, defined as follows:
X₁ corresponds to the number of fulfillment successes within a predetermined time period, where “fulfillment success” may be defined as number of Shipped fulfillment events on a per-item basis;
X₂ corresponds to the number of fulfillment failures within the predetermined time period, where “fulfillment failure” may be defined as number of Supplier Rejected fulfillment events on a per-item basis.

The predetermined time period could be set to all available history, or alternatively may be set to a more limited time frame (for example, within a set number of days, months or years).

Applying the values of Table 1 to the model in FIG. 4, the output U of the summing unit 205 is given by x₁w₁+x₂w₂. The Transfer Function 207 is given by

$$Y = {( \frac{1}{1 + {e}^{- U}} )}^{10} ,$$

where φ is chosen to be the value 1, selecting the curve labeled φ=10 in FIG. 5, to allow a bit of fulfillment history to accumulated prior reaching the highest allowed rating.

Table 1 includes example influencing factor data, x₁ and x₂, extracted from event data that would typically be logged in a Fulfillment Events database and added to a dataset 106. The extracted data includes a record for each tracked catalog item and category. Each record in Table 1 includes a catalog item identifier, its associated category identifier, a number representing the number of fulfillment successes (defined as the number of items successfully shipped) associated with the catalog item ID, a number representing the number of fulfillment failures (defined as the number of items that a supplier reported as failing to ship) associated with the catalog item ID, the result (U) output by the Summation Function for the associated catalog item ID, the Confidence calculation value (Y) for the associated catalog item ID, and the corresponding scaled Rating for the associated catalog item ID.

TABLE 1
Influencing Factor Weights

| Weight ID | Weight Value |
|---|---|
| W1 | 0.99 |
| W2 | −0.99 |

Influencing Factors

| Factor ID | Factor Description |
|---|---|
| X1 | # of Fulfillment Successes |
| X2 | # of Fulfillment Failures |

Variables

| Variable | Variable Description |
|---|---|
| U | Summation Function Output |
| Y | Confidence Level |
| R | Rating Value (on scale of 0 to 5) |

Per-Item Confidence Level

| | Category | | | | | |
|---|---|---|---|---|---|---|
| Item ID | ID | X1 | X2 | U | Y | R |
| ABC-000001 | BC | 1 | 0 | 0.99 | 0.042 | 0.2 |
| ABC-000002 | BC | 3 | 0 | 2.97 | 0.606 | 3 |
| ABC-000003 | BC | 17 | 0 | 16.83 | 1 | 5 |
| ABC-000004 | BC | 5 | 3 | 1.98 | 0.274 | 1.4 |
| ABC-000005 | BC | 16 | 12 | 3.96 | 0.828 | 4.1 |
| ABC-000006 | BC | 16 | 13 | 2.97 | 0.606 | 3 |
| ABC-000007 | BC | 16 | 14 | 1.98 | 0.274 | 1.4 |
| ABC-000008 | Posters | 1 | 0 | 0.99 | 0.042 | 0.2 |
| ABC-000009 | Posters | 2 | 0 | 1.98 | 0.274 | 1.4 |
| ABC-000010 | Posters | 3 | 0 | 2.97 | 0.606 | 3 |
| ABC-000011 | Posters | 4 | 0 | 3.96 | 0.828 | 4.1 |
| ABC-000012 | Posters | 5 | 0 | 4.95 | 0.932 | 4.7 |
| ABC-000013 | Posters | 6 | 0 | 5.94 | 0.974 | 4.9 |
| ABC-000014 | Posters | 7 | 0 | 6.93 | 0.99 | 5 |
| ABC-000015 | Posters | 8 | 0 | 7.92 | 0.996 | 5 |
| ABC-000016 | Posters | 9 | 0 | 8.91 | 0.999 | 5 |
| ABC-000017 | Posters | 10 | 0 | 9.9 | 0.999 | 5 |
| ABC-000018 | Posters | 10 | 1 | 8.91 | 0.999 | 5 |
| ABC-000019 | Posters | 10 | 2 | 7.92 | 0.996 | 5 |
| ABC-000020 | Posters | 10 | 3 | 6.93 | 0.99 | 5 |
| ABC-000021 | Posters | 10 | 4 | 5.94 | 0.974 | 4.9 |
| ABC-000022 | Posters | 10 | 5 | 4.95 | 0.932 | 4.7 |
| ABC-000023 | Posters | 10 | 6 | 3.96 | 0.828 | 4.1 |
| ABC-000024 | Posters | 10 | 7 | 2.97 | 0.606 | 3 |
| ABC-000025 | Posters | 10 | 8 | 1.98 | 0.274 | 1.4 |
| ABC-000026 | Posters | 10 | 9 | 0.99 | 0.042 | 0.2 |
| ABC-000027 | Posters | 10 | 10 | 0 | 0.001 | 0 |
| ABC-000103 | Flyers | 2 | 4 | −1.98 | 0 | 0 |
| ABC-000104 | Flyers | 1 | 0 | 0.99 | 0.042 | 0.2 |
| ABC-000105 | Flyers | 5 | 6 | −0.99 | 0 | 0 |
| ABC-000106 | Flyers | 5 | 2 | 2.97 | 0.606 | 3 |
| ABC-000107 | Flyers | 3 | 0 | 2.97 | 0.606 | 3 |
| ABC-000108 | Flyers | 4 | 2 | 1.98 | 0.274 | 1.4 |
| ABC-000109 | Flyers | 3 | 5 | −1.98 | 0 | 0 |
| ABC-000110 | Flyers | 3 | 2 | 0.99 | 0.042 | 0.2 |
| ABC-000111 | Flyers | 2 | 0 | 1.98 | 0.274 | 1.4 |
| ABC-000112 | Flyers | 1 | 1 | 0 | 0.001 | 0 |
| ABC-000113 | Flyers | 0 | 3 | −2.97 | 0 | 0 |
| ABC-000114 | Flyers | 3 | 5 | −1.98 | 0 | 0 |
| ABC-000115 | Flyers | 2 | 2 | 0 | 0.001 | 0 |
| ABC-000116 | Flyers | 6 | 5 | 0.99 | 0.042 | 0.2 |
| ABC-000117 | Flyers | 2 | 1 | 0.99 | 0.042 | 0.2 |
| ABC-000118 | Flyers | 5 | 8 | −2.97 | 0 | 0 |
| ABC-000119 | Flyers | 1 | 0 | 0.99 | 0.042 | 0.2 |

Table 2 shows a per-Category confidence calculation which includes, on a per-Category-ID basis, the result from the Summation Function (U) (which sums the total number of successes, using the data in Table 1, for all Item IDs which are associated with the particular category), the Confidence calculation (Y), and the corresponding scaled Rating.

TABLE 2

| | Category Confidence Level | | |
|---|---|---|---|
| Category ID | U | Y | R |
| BC | 31.68 | 1 | 5 |
| Posters | 99 | 1 | 5 |
| Flyers | 1.98 | 0.274 | 1.4 |

The Rating values in Tables 1 and 2 demonstrate how Ratings change based on their influencing factors. In the above calculations, φ was set to the value 10. At this learning rate, a given Item ID with no history starts out with a Rating of 0. After one successful fulfillment (and no failures) (i.e., X1=1 and X0=1), the Confidence and Rating levels associated with the Item ID begins to increase. (See, for example, Item ID ABC-000001 in Table 1, which has a history of 1 successful fulfillment, and no failed fulfillments). The Confidence is 0.042 and the Rating begins to creep up from zero to 0.2. After another success and no failures, the Confidence and Rating levels associated with the Item ID further increases. See, for example, Item ID ABC-000009 in Table 1, which has a history of 2 successful fulfillments, and no failed fulfillments, resulting in a Confidence value of 0.274 and a Rating of 1.4. Another successful fulfillment increases the Rating to 3, and further successes further increase the Rating, which plateaus at 5 after the 6^{th} success with no failures (see Item ID ABC-000014 in Table land how additional successes with no failures shown by Item IDs ABC-000015 through ABC-000017 in Table 1 have maxed out at a Rating of 5). The Confidence and Rating can be adjusted to give successes versus failures more or less weight by adjusting the weights W1 and/or W2. In Table 1, the Confidence value was calculated using weights W1=0.99 and W2=−0.99, so that a success maximally impacts the Confidence value in a positive direction and a failure maximally impacts the Confidence value in a negative direction. If one wanted to bias the Ratings to favor successes, one could adjust the weight of W2 towards 0—for example to −0.75 or −0.5 or some other negative value closer to 0. Similarly, if one wanted to bias the Ratings to be more sensitive to failures, one could adjust the weight of W1 towards 0—for example to 0.75 or 0.5 or some other positive value closer to 0. The above values for parameters used in the Confidence calculations are merely examples, and one could change any of the values to suit the desired learning rate or direction of bias (i.e., to favor one influencing factor over another).

Referring back to FIG. 4, the respective weights w₁, w₂, . . . , wₖ may be predetermined and fixed to the respective predetermined values, as in the above example. Alternatively, the weights w₁, w₂, . . . , wₖ may be dynamically adjusted in realtime by implementing error feedback. In such implementation, the confidence value Y is compared (by differencing element 210) to an expected confidence value Y′, and the difference e=Y−Y′, 211, is used to adjust the weights in realtime.

### Second Embodiment—Confidence Level Calculation Using Neural Network

In an alternative embodiment, the confidence model 109 is a software- or hardware-implemented artificial neural network or other machine learning classifier.

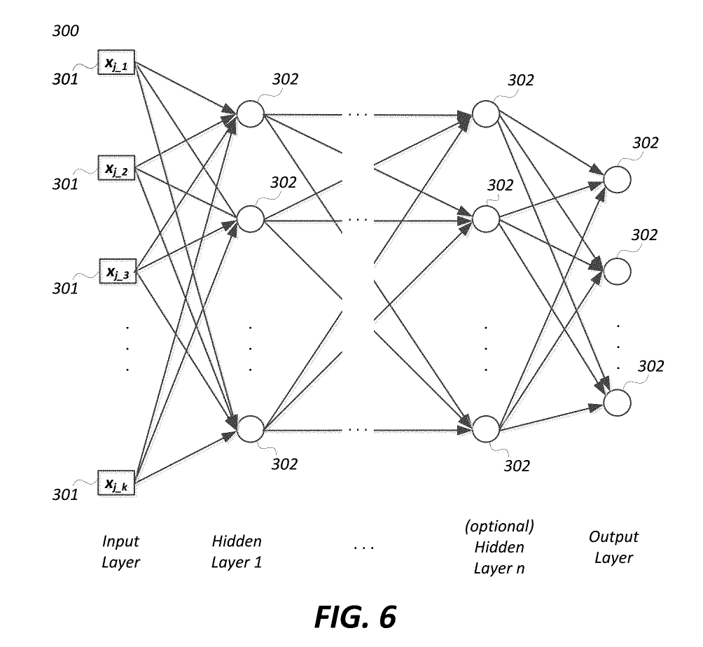

FIG. 6 is a schematic diagram of an example artificial neural network 300. As illustrated, the neural network 300 comprises a plurality of adjacent forward feeding layers (input layer, hidden layer 1, . . . , hidden layer n, output layer). The input layer comprises a plurality of input nodes, each of which receives a respective feature value xⱼ_{_}ₖ from the input vector xⱼ and which together serve as the input signals to the neural network 300. Each of the hidden layers and the output layer comprise one or more neurons 302, discussed hereinafter. The input nodes 301 feed the inputs to the neurons 302 in the first forward hidden layer (Hidden Layer 1). Each of the output signals of the neurons 302 in the first hidden layer are used as inputs to the neurons 302 in the next forwardly adjacent hidden layer (if one exists), and the outputs of those neurons operate as the inputs to the neurons 302 in the next forwardly adjacent hidden layer (if one exists). The output layer, which as shown in FIG. 6 comprises one or more neurons 302 which each receive as inputs the outputs of the last hidden layer (Layer n).

Neural network 300 is an example of a feedforward network in that the outputs of each layer, in the direction from input to output, feed the input(s) of the immediate forwardly-adjacent layer. Neural network 300 is also an example of a fully-connected feedforward network in that the output of each neuron 302 in a hidden layer is input to each neuron 302 in the immediate forwardly-adjacent layer.

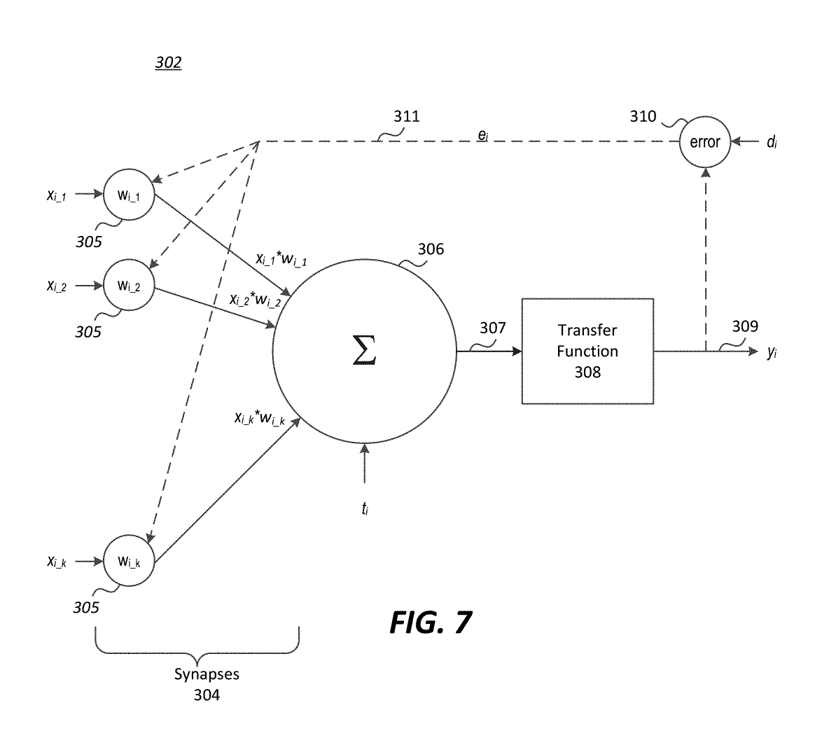

As illustrated in FIG. 6, neural networks are built using artificial neurons 302. FIG. 7 is a schematic diagram of an individual artificial neuron 302. In neural network terminology, a neuron 302 comprises a plurality, k, of synapses, each characterized by a respective weight wᵢ_{_}₁, wᵢ_{_}₂, . . . , wᵢ_{_}ₖ, a summing unit 306, and a transfer function 308. A set of respective input signals xᵢ_{_}₁, xᵢ_{_}₂, . . . xᵢ_{_}ₖ, corresponding to features of vector x (referred to herein as “influencing factors”), are respectively input to each synapse 304. Each synapse 304 has associated therewith a respective weight, wᵢ_{_}₁, wᵢ_{_}₂, . . . , wᵢ_{_}ₖ, and includes a multiplier 305 which multiplies its respective input signal xᵢ_{_}₁, xᵢ_{_}₂, . . . xᵢ_{_}ₖ with its respective weight wᵢ_{_}₁, wᵢ_{_}₂, . . . , wᵢ_{_}ₖ, to generate a respective weighted signal, xᵢ_{_}₁wᵢ_{_}₁xᵢ_{_}₂wᵢ_{_}₂, . . . xᵢ_{_}ₖwᵢ_{_}ₖ. The summing unit 306 sums the weighted signals produced at each of the synapses to produce a combined signal 307.

The transfer function 308 maps the combined signal 307 to a limited range of outputs. In a preferred embodiment, the transfer function 308 is a sigmoid function, which is a strictly increasing “S”-shaped function that is defined by f(x)=1/(1+exp(−φx)), where φ=1 is the slope parameter of the sigmoid function, as illustrated in FIG. 5. The transfer function 308 limits the amplitude of the output of a neuron to map the permissible amplitude range of the output signal to a predetermined finite value. In some implementations, a neuron may also include an externally applied bias, b, which operates to offset the net input of the transfer function higher or lower, depending on whether it is positive or negative, respectively.

Given the model of an artificial neuron, it is clear that the inputs to the neuron, xᵢ_{_}₁, xᵢ_{_}₂, . . . xᵢ_{_}ₖ must be numeric and, preferably, normalized. The input signals must be numeric in order to perform the multiplication and summation operations performed respectively by the synapse multipliers 305 and summing unit 306 of the neuron 302. Preferably, the input signals are normalized to a common scale so that an input to one synapse which is characterized by a large range of values does not overwhelm the effects of an input to another synapse which is characterized by a small range of values—that is, so that if a first feature in an input vector can take on a value within a large range of values and second feature in the input vector can only take on a value within a very small range of values, the first feature does not overshadow the second feature due to the larger potential differences in its values. In an embodiment, the inputs are each encoded to a numeric value, and normalized to values that range between 0 and 1.

In an embodiment, the artificial neural network is a feed-forward network, and the weights are pre-determined (i.e., pre-set and fixed).

Alternatively, the neural network could implement back propagation to allow for automatic weight adjustment. If using back-propagation, the artificial neural network may first be trained during a learning mode using a test dataset which embodies fulfillment events that are either in fact production data, or which are known to be typically seen by a procurement system. The trained neural network is then stored in computer-readable storage 108 as a data model 109 and may be used to process realtime per-item/category input vectors to update the fulfillment success confidence levels associated items and categories of items.

During the learning mode, the neurons in a neural network are trained with input vectors and expected corresponding outputs. A difference function (e.g., a subtractor) 310 calculates the difference, called the error signal, eᵢ, 311 between the expected output dᵢ for the input vector and the calculated output value yᵢ. The error signal eᵢ is used to adjust the respective weights, wᵢ_{_}₁, wᵢ_{_}₂, . . . , wᵢ_{_}ₖ, of the respective synapses 304. There are various techniques for training a neural network, which are well known in the art. Training typically is performed until the error signal eᵢ reaches or falls below a particular error threshold. Once the neural network is trained, the weights may be made static (by no longer allowing adjustment to the weights), and the neural network with static weights is considered a “model” which models the dataset.

The use of the fulfillment success prediction capability in an electronic procurement environment allows a procurer to not only ascertain a level of confidence that an ordered product will be fulfilled successfully, but also allows procurement teams to perform a deeper evaluation of a supplier, and in particular an evaluation of a supplier on a product by product basis rather than the traditional basis which rates a supplier over all products in aggregate. Such evaluation may reveal that the supplier is very good at fulfilling certain products, yet has trouble fulfilling certain other products, yet still allows the procurer to identify that it may well benefit from sourcing the products typically fulfilled at high success rates from that particular supplier (for reasons that may include the supplier's product availability and pricing), yet avoid sourcing products typically fulfilled at low success rates from that same supplier. The electronic procurement system fulfillment success prediction capability may also assist suppliers in more quickly identifying which of its own products are failing fulfillment, and to thereby focus on improving fulfillment of such identified products and/or to remove the identified products from their offerings, in order to more quickly improve how they rate, from the procurer's perspective, as a supplier. This eliminates the need for a supplier to test every single product and use such confidence level to learn and only test a subset of products.

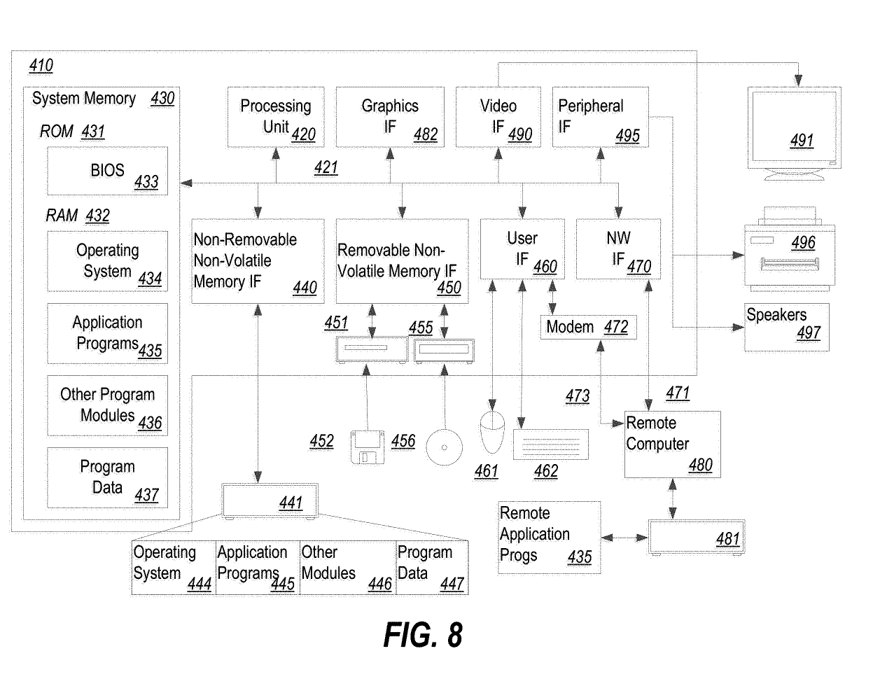

FIG. 8 illustrates a computer system 410 that may be used to implement or incorporate any of the computer processing unites, servers, computer systems, and/or networked, distributed and/or mobile devices discussed herein. Components of computer 410 may include, but are not limited to, a computer processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 410. Computer storage media typically embodies computer readable instructions, data structures, program modules or other data.

The system memory 430 includes computer storage media in the form of volatile and/or nonvolatile memory such as read only memory (ROM) 431 and random access memory (RAM) 432. ROM 431 typically stores the basic input/output system 433 (BIOS), containing the basic routines that help to transfer information between elements within computer 410, such as during start-up. RAM 432 typically contains data and/or program modules that are immediately accessible to and/or presently being operated on by processing unit 420. By way of example, and not limitation, FIG. 8 illustrates operating system 434, application programs 435, other program modules 436, and program data 437.

The computer 410 may also include other removable/non-removable, volatile/nonvolatile computer storage media. By way of example only, FIG. 8 illustrates a hard disk drive 440 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through one or more non-removable memory interface(s) such as interface 440, and magnetic disk drive 451 (which read and/or write magnetic disks 452) and optical disk drive 455 (which reads and/or writes optical discs 456) are typically connected to the system bus 421 by one or more removable memory interface, such as interface 450.

The drives and their associated computer storage media discussed above and illustrated in FIG. 8 provide storage of computer readable instructions, data structures, program modules and other data for the computer 410. In FIG. 8, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 490.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 8. The logical connections depicted in FIG. 8 include a local area network (LAN) 471 and a wide area network (WAN) 473, but may also include other networks. Networks may be wired (using a network protocol such as but not limited to Ethernet, FDDI, ATM), and/or wireless (via one or more wireless protocols such as but not limited to IEEE 2G (GSM), 3G and 5G standard protocols). Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. It will be appreciated that the network connections shown are exemplary and other means of establishing a communications link between the computers may be used.

In a networked environment, program modules depicted relative to the computer 410, or portions thereof, may be stored in the remote memory storage device. By way of example, and not limitation, FIG. 8 illustrates remote application programs 485 as residing on memory device 481. Remote computer 480 may be a remote device such as a device connected to the Internet which runs one or more servers and through which one or more web services are accessible by the computer system 410. The computer system 410 may connect to any number of remote computers 480 and access any number of documents, web services, or resource available via servers, web services, and/or other remote storage and/or service access. Referring to FIG. 1, for example, user computer system 10 may be implemented by a computer system, such as computer system 410 in FIG. 8, as a cloud client and connect to any number of remote cloud-based system(s) (such as one or more instances of remote computer 480 in FIG. 8). In an embodiment, the procurement system 2, the fulfillment success prediction system 8, and the events database 6 are each accessible as one or more web services via the Internet using one or more web service Application Program Interfaces (APIs). Such web services may execute on web servers accessible via the Internet from the “Cloud” by way of corresponding cloud APIs. In an embodiment, one or more instances of the procurement system 2, the fulfillment success prediction system 8, and/or the events database management system 6 are stored, accessed and implemented using AWS available through Amazon Web Services, Inc.

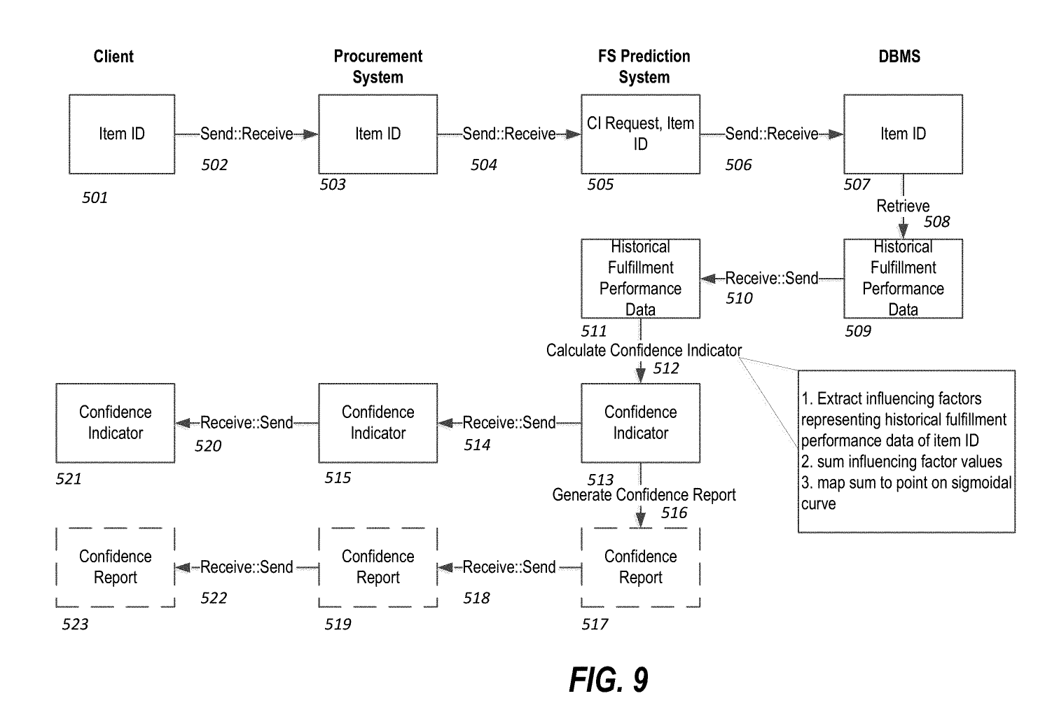

FIG. 9 is a flowchart illustrating an exemplary communications flow between the client user computer system 10, the procurement system 2, the fulfillment success prediction system 8 and the events database management system 6. As illustrated, the client selects or obtains an item identifier 501 corresponding to an item to be procured. The item ID 501 (or proxy thereof) is sent to, and received by (step 502) the procurement system 2. The item ID 503 (or mapped version thereof) is sent to, and received by (step 504) the fulfillment success prediction system 8. The fulfillment success prediction system 8 sends, and the events database management system receives (step 506), the item ID 505 and a request for a confidence indicator 507. The DBMS 6 retrieves (step 508) the historical fulfillment performance data 509 required by the fulfillment success prediction system 8 to calculate the confidence indicator. The DBMS 6 sends, and the fulfillment success prediction system 8 receives (step 510) the retrieved historical fulfillment performance data 511. As mentioned previously, the historical fulfillment performance data 511 is preferably in a format such as a vector containing influencing factor values. The fulfillment success prediction system 8 calculates (step 512) the confidence indicator 513 associated with the Item ID.

In an embodiment, the confidence indicator is calculated by extracting influencing factors representing historical fulfillment performance data of the item ID, summing the influencing factor values, and mapping the sum to a point on a sigmoidal curve, per the discussion relating to FIGS. 4-7.

At this point, the fulfillment success prediction system 8 may send, and the procurement system 2 may receive (step 514), the confidence indicator 515. Alternatively, the fulfillment success prediction system 8 may generate (step 513) a report 517 which includes the confidence indicator and additional information such as historical fulfillment performance data and/or comparison data (confidence indicator and/or historical fulfillment performance data) of Item IDs of other comparable items. The fulfillment success prediction system 8 sends, and the procurement system 2 receives (step 518) the confidence report 519. The procurement system 2 sends, and the client receives (step 520 and/or 522) the confidence indicator 521 and/or confidence report 523. The user, or the application/system operating on, the client can use the confidence indicator 521 and/or confidence report 523 to make decisions about proceeding with procurement of items corresponding to the item ID.

It will be of note that the client, while shown in the illustrative embodiment as a user computer system operable by a human user, can be a computer system or other system executing another application or system which uses, or which has integrated therein, directly or via calls thereto (remote or local), the procurement system 2 and fulfillment success prediction system 8. It will also be of note that of course the procurement system 2 and fulfillment success prediction system 8 may be integrated into a single application. Additionally, the fulfillment success prediction system 8 may be a service that operates entirely independently of the procurement system 2, and used, for example, as a 3^{rd} party utility that procurement systems, analysts, and other applications or computers can access to obtain fulfillment success prediction indicators from which to base decision-making in procurement choices.

Those of skill in the art will appreciate that the invented method and apparatus described and illustrated herein may be implemented in software, firmware or hardware, or any suitable combination thereof. Thus, those of skill in the art will appreciate that the methods and systems described herein may be implemented by one or more processors executing computer-readable instructions being stored for execution on one or more computer-readable media. Alternative embodiments are contemplated, however, and are within the spirit and scope of the invention.

Although this preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An electronic procurement system, comprising:
at least one communications interface through which electronic messages are transmitted and received via a network through which the electronic procurement system is in electronic communication with one or more suppliers of items offered for procurement;
one or more computer processing units;
computer-readable storage storing computer readable instructions executable by the one or more central processing units and storing data used during processing of the computer readable instructions,
the computer readable instructions implementing a user interface through which an item to be procured from a supplier is ordered from a supplier by a user interacting with the user interface,
the computer readable instructions implementing selecting an item identifier corresponding to an item selected by a user to be procured, requesting from an electronic fulfillment success prediction service a fulfillment confidence indicator corresponding to the item identifier, and receiving from the electronic fulfillment success prediction service the requested fulfillment confidence indicator corresponding to the item identifier; and
wherein the fulfillment success prediction service receives the request for the fulfillment confidence indicator corresponding to the item identifier, and generates and transmits to the procurement system the fulfillment confidence indicator corresponding to the item identifier, the fulfillment success prediction service generating the fulfillment confidence indicator corresponding to the item identifier by retrieving from an electronic database a vector of historical values corresponding to a plurality of influencing factors representing historical fulfillment performance data corresponding to the item identifier, summing the historical values corresponding to the plurality of influencing factors, and mapping the sum to a point on a sigmoidal curve to generate the fulfillment confidence indicator corresponding to the item identifier.

2. The system of claim 1, wherein the received fulfillment confidence indicator corresponding to the item is scaled proportionally to a predetermined rating scale.

3. The system of claim 1,
wherein the influencing factors have associated therewith respective weights; and
wherein the generating step comprises multiplying the historical values corresponding to the plurality of influencing factors by the respective corresponding influencing factor weights to generate corresponding weighted historical values corresponding to the plurality of influencing factors, and using the weighted historical values as the historical values in the summing step.

4. The system of claim 1, wherein the received fulfillment confidence indicator corresponding to the item is scaled proportionally to a predetermined rating scale.

5. The system of claim 1, wherein the fulfillment success prediction service comprises a web service that is accessible via a web interface.

6. The system of claim 5, wherein the web interface comprises an application program interface.

7. The system of claim 1, wherein the received fulfillment confidence indicator corresponding to the item identifier is represented in a report document.

8. The system of claim 1, wherein the procurement system submits to the supplier via one of the communications interfaces an order for the item identifier if the received fulfillment confidence indicator is above a predetermined threshold.

9. A method for providing fulfillment confidence within an electronic procurement system, the electronic procurement system in communication via a communication link with an electronic database storing historical fulfillment event information, the method comprising:
the procurement system receiving via a communication link an identifier of an item to be procured from a supplier;
the procurement system transmitting to an electronic fulfillment success prediction service a request for a fulfillment confidence indicator corresponding to the item to be procured;
the procurement system receiving from the fulfillment success prediction service, via a communication link, the fulfillment confidence indicator corresponding to the item to be procured; and
wherein the fulfillment success prediction service receives via a communication link the request for the fulfillment confidence indicator corresponding to the item to be procured, and generates and transmits via a communication link to the procurement system the fulfillment confidence indicator corresponding to the item to be procured, the fulfillment success prediction service generating the fulfillment confidence indicator corresponding to the item to be procured by receiving via a communication link from the electronic database a vector of historical values corresponding to a plurality of influencing factors representing historical fulfillment performance data corresponding to the item, summing the historical values corresponding to the plurality of influencing factors, and mapping the sum to a point on a sigmoidal curve to generate the fulfillment confidence indicator corresponding to the item.

10. The method of claim 9, wherein the received fulfillment confidence indicator corresponding to the item is scaled proportionally to a predetermined rating scale.

11. The method of claim 9, wherein
the influencing factors have associated therewith respective weights, and wherein the generating step comprises multiplying the historical values corresponding to the plurality of influencing factors by the respective corresponding influencing factor weights to generate corresponding weighted historical values corresponding to the plurality of influencing factors, and using the weighted historical values as the historical values in the summing step.

12. The method of claim 9, wherein the received fulfillment confidence indicator corresponding to the item is scaled proportionally to a predetermined rating scale.

13. The method of claim 9, the procurement system receiving the identifier of the item to be procured from a human user of the procurement system via a graphical user interface executing by a computer processing unit on a user device and receiving user input that represents the item identifier via an input control on the graphical user interface.

14. The method of claim 9, wherein the fulfillment success prediction service comprises a web service that is accessible via a web interface.

15. The method of claim 9, wherein the web interface comprises an application program interface.

16. The method of claim 9, wherein the received fulfillment confidence indicator corresponding to the item to be procured is represented in a report document.

17. The method of claim 9, wherein the procurement system submits to the supplier an order for the item to be procured if the received fulfillment confidence indicator is above a predetermined threshold.
